(19) United States
(12) Patent Application Publication
(10) Pub. No.: US 2020/0079175 A1
(43) Pub. Date: Mar. 12, 2020

(54) CAB WITH FRESH AIR PATH THROUGH THE POSTS

(71) Applicant: CNH Industrial America LLC, New Holland, PA (US)

(72) Inventors: Robert Fiocchi, Chicago, IL (US); Kaushal Ghorpade, Chicago, IL (US); Leonid Chernyavsky, Glenview, IL (US); Samrendra K. Singh, Bolingbrook, IL (US)

(73) Assignee: CNH Industrial America LLC, New Holland, PA (US)

(21) Appl. No.: 16/123,571

(22) Filed: Sep. 6, 2018

(51) Int. Cl. B60H 1/00; B60H 1/24; B60H 3/06

(52) U.S. Cl. CPC B60H 1/00378; B60H 1/00564; B62D 33/0617; B60H 3/06; B60H 1/243

(57) ABSTRACT

A vehicle including a cab having a frame with at least two support posts each including an airflow path therein and an airflow system supported by the cab and configured for increasing an airflow into the cab and decreasing a power consumption of the cab. The airflow system includes at least one air intake opening in the cab configured for intaking a fresh air, an air filter fluidly coupled to the at least one air intake opening, and an air outlet within the cab and fluidly coupled with the air filter. The fresh air flows into the at least one air intake opening, through each respective airflow path of the at least two support posts, is filtered by the air filter, and flows out through the air outlet into the cab.

### FIELD OF THE INVENTION

The present invention pertains to vehicles and, more specifically, to airflow systems for ventilating the cab of the vehicle.

### BACKGROUND OF THE INVENTION

Work vehicles, such as agricultural or industrial vehicles, may include an enclosed cab for housing and shielding the operator of the work vehicle. The cab generally includes a frame with a roof, a floor, support posts, a windshield and windows, and an airflow system which provides the interior of the cab with fresh air.

A typical airflow system for a cab includes an air inlet, air conduits, an air filter, and an air outlet for dispensing the filtered air into the interior of the cab. Since the work vehicle is generally operated off-road, the fresh air surrounding the work vehicle can be filled with particulate matter, such as dust, pollen, exhaust fumes, suspended particles of crop material and/or fertilizer, etc. Thereby, the air inlet is generally positioned in the roof of the cab, i.e., an area which usually has a lower concentration of particulate matter within the surrounding air. The air filter is often located at the floor of the cab, which can allow for ease of access when servicing the air filter. The air outlet can be located at the floor of the cab, for example, underneath the chair upon which the operator sits. The airflow system may additionally include a heating, ventilation, and air conditioning (HVAC) unit for conditioning and ventilating the air to meet the operator's preferences. Some airflow systems may also include a pressure differential fan for forcibly moving the air into the cab.

Various airflow systems have been contemplated in the prior art. It is known from U.S. Pat. No. 8,459,727 to have a cab with roof air intakes, support pillars of the Roll Over Protection Structure (ROPS), an HVAC unit, a pressurization blower, a main blower, and an air outlet. The two rear pillars of the ROPS are hollow and funnel the air to the HVAC unit. The pressurization blower overcomes the pressure drop caused by the long air intake path, which can be restrictive due to airflow paths within the support pillars. As described in U.S. Pat. No. 8,459,727, without the pressurization blower, the air flow from the HVAC unit would be too small for reasonable system performance. It is also known from U.S. Pat. No. 5,119,718 to have a cab with vertical air ducts that sheath the two rear posts. Such prior art systems may lead to a restricted airflow, a lower air pressure within the cab, a poorer air quality within the cab, and/or may cause an increased power consumption due to operating a pressure differential fan.

What is needed in the art is a cost-effective and energy efficient airflow system for a cab of a work vehicle.

### SUMMARY OF THE INVENTION

In one exemplary embodiment formed in accordance with the present invention, there is provided a work vehicle with a cab that has two or more support posts with airflow paths therein and an airflow system. The airflow system includes at least one air intake opening, an air filter, and an air outlet. The cab allows fresh air to enter into the air intake opening, through two or more support posts, through the filter, and into the cab such that the airflow into the cab is increased by the two or more parallel airflow paths within the support posts while minimizing a power consumption required by the cab.

In another exemplary embodiment formed in accordance with the present invention, there is provided a vehicle including a cab having a frame with at least two support posts each including an airflow path therein and an airflow system supported by the cab and configured for increasing an airflow into the cab and decreasing a power consumption of the cab. The airflow system includes at least one air intake opening in the cab configured for intaking a fresh air, an air filter fluidly coupled to the at least one air intake opening, and an air outlet within the cab and fluidly coupled with the air filter. The fresh air flows into the at least one air intake opening, through each respective airflow path of the at least two support posts, is filtered by the air filter, and flows out through the air outlet into the cab.

In yet another exemplary embodiment formed in accordance with the present invention, there is provided a cab for a vehicle. The includes a frame having at least two support posts each including an airflow path therein and an airflow system configured for increasing an airflow into the cab and decreasing a power consumption of the cab. The airflow system includes at least one air intake opening configured for intaking a fresh air, an air filter fluidly coupled to the at least one air intake opening, and an air outlet fluidly coupled with the air filter, wherein the fresh air is configured to flow into the at least one air intake opening, through each respective airflow path of the at least two support posts, to be filtered by the air filter, and flow out through the air outlet into the cab.

In yet another exemplary embodiment formed in accordance with the present invention, there is provided a method for ventilating a vehicle. The method includes the step of providing a cab configured for the vehicle. The cab includes a frame having at least two support posts each including an airflow path therein and an airflow system configured for increasing an airflow into the cab and decreasing a power consumption of the cab. The airflow system includes at least one air intake opening configured for intaking a fresh air, an air filter fluidly coupled to the at least one air intake opening, and an air outlet fluidly coupled with the air filter. The method additionally includes the steps of intaking the fresh air into the at least one air intake opening, flowing the fresh air through each respective airflow path of the at least two support posts, filtering the fresh air by the air filter, and outflowing a filtered fresh air out through the air outlet into the cab.

One possible advantage of the exemplary embodiment of the vehicle is that the two or more support posts provide for additional and parallel airflow pathways so that the cabin is sufficiently provided with air.

Another possible advantage of the exemplary embodiment of the vehicle is that the airflow system increases the airflow to the cab while minimizing the power required, by lowering the power requirements of the blower or by not needing to include a blower, and increasing the service interval for the fresh air filter.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown Like numerals indicate like elements throughout the drawings. In the drawings:

FIG. 1 illustrates a perspective view of an exemplary embodiment of a work vehicle, the work vehicle including a cab with two or more posts with air pathways therein for providing fresh air inside the cab; and

FIG. 2 illustrates a perspective view of another exemplary embodiment of a work vehicle, the work vehicle including a cab with two or more posts with air pathways therein for providing fresh air inside the cab, and the two or more posts include additional air intake ports.

### DETAILED DESCRIPTION OF THE INVENTION

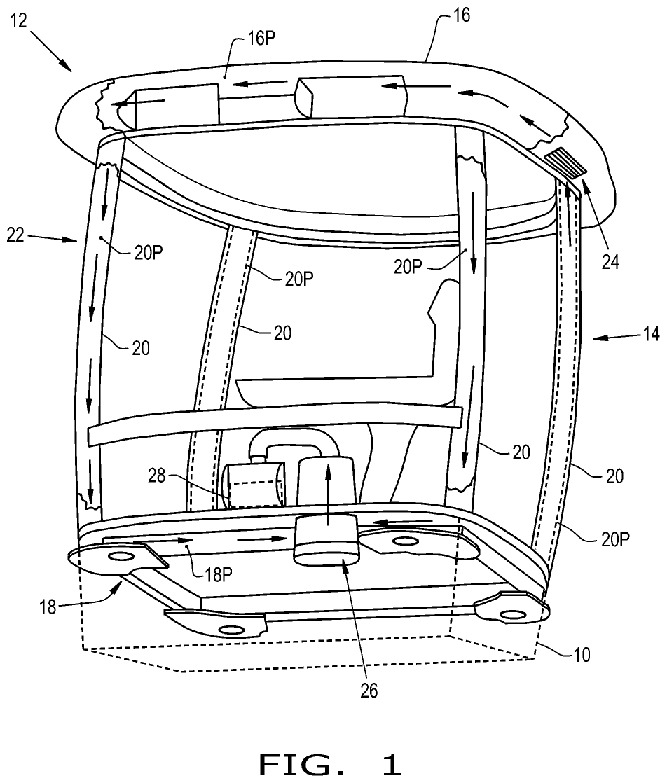

Referring now to the drawings, and more particularly to FIG. 1, there is shown an embodiment of a work vehicle 10 having a chassis and a cab 12 supported by the chassis. The work vehicle 10 may be in the form of any desired work vehicle, such as an industrial vehicle or agricultural vehicle. As shown, the work vehicle 10 is in the form of an agricultural vehicle 10, e.g. a combine or tractor. The cab 12 may generally include a frame 14, a roof 16 with a roof airflow path 16P, a floor 18 with a floor airflow path 18P, support posts 20, and an airflow system 22 which is integral with and supported by the cab 12.

The frame 14 of the cab 12 may be in the form of a Roll Over Protection Structure (ROPS) which has multiple support posts, such as the vertical support posts 20. For instance, the frame 14 may include four vertical support posts 20. Each support post 20 may be in the form of an A or C post. The support posts 20 may be hollow or at least partially hollow. One or more of the support posts 20 may have re-enforcement beams or electrical cables running therethrough. Additionally, at least two of the support posts 20, such as the front two support posts 20, may each have an airflow path 20P therein. Also, for example, three or all of the support posts 20 may have an airflow path 20P therein (as shown in phantom in FIG. 1).

The airflow system 22 generally includes at least one air intake opening 24 in the cab 12 for intaking the fresh air, an air filter 26 fluidly coupled to the intake opening 24, and an air outlet 28 within the cab 12 and fluidly coupled with the air filter 26. The airflow system 22 is configured for increasing airflow within the cab 12 and reducing the power consumption of the cab 12. The airflow system 22 overcomes the aforementioned issues of airflow restriction and lower air pressure within the cab 12 by providing multiple and parallel airflow paths 20P. Hence, the multiple airflow paths 20P in turn reduce air side restriction and draw the desired amount of fresh air into the cab 12 with less power input required.

The airflow system 22 may also include an HVAC unit and a main blower fan (unnumbered). The airflow system 22 may or may not include a designated pressure differential fan, such as a pressurization blower, to forcibly move the air through the system. As shown, the airflow system 22 does not include a designated pressure differential fan. Thereby, the airflow paths 20P of the two or more support posts 20 increases the airflow into the cab 12 while minimizing the power requirements, for example, by lowering the requisite load of the main blower in order to intake or circulate the air and/or by not needing to include a designated pressurization blower. In this regard, the airflow system 22 provides multiple airflow paths 20P in order to increase air quality and air pressure while reducing the power input required by the cab 12.

The air intake opening 24 may be located at one side of and embedded within the roof 16 of the cab 12. The air intake opening 24 may be in the form of a vent 24 or any other desired intake opening. It should be appreciated that the air intake opening 24 may be one, two, or more intake openings 24 within the roof 16 of the cab 12.

As shown, the roof airflow path 16P fluidly couples the single air intake opening 24 to each airflow path 20P of the two or more support posts 20. However, multiple roof airflow paths 16P may be used to channel air from any number of intake openings 24 to two, three, or all of the airflow paths 20P of the support posts 20. In an alternative embodiment, the roof airflow path 16P may alternatively be in the form of one or more interior airflow paths within the upper, horizontal beams of the ROPS frame 14 (not shown). In this regard, the interior airflow paths within the horizontal beams of the ROPS frame 14 may allow for a larger cross-sectional flow channel, which in turn allows for an increased air pressure and air quality within the cab 12.

The air filter 26 may be located at the floor 18 of the cab 12. The air filter 26 may be in the form of any desired, commercially available air filter. The air filter 26 may also include more than one filtration device, such as a primary and secondary filter. As shown, the floor airflow path 18P fluidly couples each airflow path 20P of the two or more support posts 20. However, multiple floor airflow paths 18P may be used to fluidly couple the airflow paths 20P to the air filter 26.

The air outlet 28 is located at the floor 18 of the cab 12. The air outlet 28 can be a vent 28 or any other desired air outlet 28. It should be appreciated that the air outlet 28 may be in the form of one, two, or more air outlets 28 which may be located at any desired location in the cab 12.

In operation, and referenced by the arrows, the fresh air flows into the air intake opening(s) 24 at the roof 16 of the cab 12. From the air intake opening(s) 24, the fresh air flows horizontally through the roof airflow path 16P, to each respective airflow path 20P of the two or more support posts 20. The fresh air then flows vertically downward through each airflow path 20P, and horizontally through the floor airflow path 18P to the air filter 26. The filtered fresh air is channeled to the air outlet 28 which dispenses or outflows the filtered fresh air into the cab.

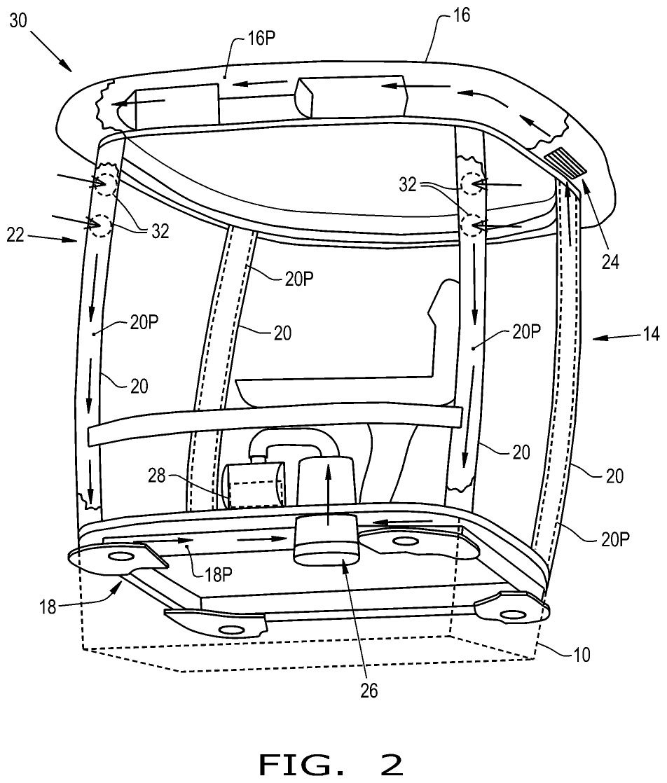

Referring now to FIG. 2, there is shown an alternative embodiment of a cab 30 for a work vehicle 10. The cab 30 may be substantially similar to the cab 12 except that the cab 30 includes support posts 20 with air intake ports 32; thereby, like parts have been identified with like reference characters.

One or more of the support post(s) 20 which include the airflow path 20P may further include at least one air intake port 32 that allows fresh air to be drawn therein in addition to the fresh air entering the intake opening 24 at the roof 16 of the cab 30, as referenced by the arrows indicating the airflow. The two front support posts 20 may each include at least one intake port 32, such as a pair of intake ports 32 as shown in FIG. 2. It should be appreciated that all of the support posts 20 may include airflow paths 20P and air intake ports 32.

The air intake ports 32 can be in the form of cutouts, vents, and/or intake channels extending above the outer surface of a respective support post 20. The intake ports 32 can be located at any desired location on the support posts 20, for example, such as near the top of the support posts 20. As shown, the intake ports 32 are circular, however, the intake ports 32 may have any desired shape. As can be appreciated, the intake ports 32 of the embodiment shown in FIG. 2, allow for an increased intake of airflow; and thereby, the intake ports 32 help to increase airflow into the cab 30.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A vehicle, comprising:
a cab having a frame with at least two support posts each including an airflow path therein; and
an airflow system supported by the cab and configured for increasing an airflow into the cab and decreasing a power consumption of the cab, including:
at least one air intake opening in the cab configured for intaking a fresh air;
an air filter fluidly coupled to the at least one air intake opening; and
an air outlet within the cab and fluidly coupled with the air filter, wherein the fresh air flows into the at least one air intake opening, through each respective airflow path of the at least two support posts, is filtered by the air filter, and flows out through the air outlet into the cab.

2. The vehicle of claim 1, wherein the cab includes a roof with a roof airflow path therein, the at least one air intake opening is located in the roof, and the roof airflow path fluidly couples the at least one air intake opening with each respective airflow path of the at least two support posts.

3. The vehicle of claim 2, wherein at least one support post of the at least two support posts including the airflow path therein includes at least one air intake port that is configured for intaking the fresh air in addition to the at least one air intake opening.

4. The vehicle of claim 3, wherein the at least two support posts each include a pair of air intake ports.

5. The vehicle of claim 4, wherein the at least one air intake opening is in the form of one air intake opening located at a side of the roof of the cab, and the pair of air intake ports are respectively located at a top of each support post.

6. The vehicle of claim 2, wherein the cab further includes a floor having a floor airflow path therein fluidly coupling each respective airflow path of the at least two support posts, the air filter is located at the floor of the cab, and the fresh air enters the at least one air intake opening, flows horizontally through the roof airflow path, flows downwardly through each respective airflow path of the at least two support posts, flows through the floor airflow path, and into the air filter such that the airflow into the cab is increased while the power consumption of the cab is decreased.

7. The vehicle of claim 1, wherein the airflow system decreases the power consumption of the cab by being configured for decreasing a requisite load of a main blower and not including a designated pressurization blower.

8. A cab for a vehicle, comprising:
a frame having at least two support posts each including an airflow path therein; and
an airflow system configured for increasing an airflow into the cab and decreasing a power consumption of the cab, including:
at least one air intake opening configured for intaking a fresh air;
an air filter fluidly coupled to the at least one air intake opening; and
an air outlet fluidly coupled with the air filter, wherein the fresh air is configured to flow into the at least one air intake opening, through each respective airflow path of the at least two support posts, to be filtered by the air filter, and flow out through the air outlet into the cab.

9. The cab of claim 8, further including a roof with a roof airflow path therein, the at least one air intake opening is located in the roof, and the roof airflow path fluidly couples the at least one air intake opening with each respective airflow path of the at least two support posts.

10. The cab of claim 9, wherein at least one support post of the at least two support posts including the airflow path therein includes at least one air intake port that is configured for intaking the fresh air in addition to the at least one air intake opening.

11. The cab of claim 10, wherein the at least two support posts each include a pair of air intake ports.

12. The cab of claim 11, wherein the at least one air intake opening is in the form of one air intake opening located at a side of the roof of the cab, and the pair of air intake ports are respectively located at a top of each support post.

13. The cab of claim 9, further including a floor having a floor airflow path therein fluidly coupling each respective airflow path of the at least two support posts, the air filter is located at the floor of the cab, and the fresh air enters the at least one air intake opening, flows horizontally through the roof airflow path, flows downwardly through each respective airflow path of the at least two support posts, flows through the floor airflow path, and into the air filter such that the airflow into the cab is increased while the power consumption of the cab is decreased.

14. A method for ventilating a vehicle, comprising the steps of:
providing a cab configured for the vehicle, the cab including a frame having at least two support posts each including an airflow path therein, an airflow system configured for increasing an airflow into the cab and decreasing a power consumption of the cab, the airflow system including at least one air intake opening configured for intaking a fresh air, an air filter fluidly coupled to the at least one air intake opening, and an air outlet fluidly coupled with the air filter;
intaking the fresh air into the at least one air intake opening;
flowing the fresh air through each respective airflow path of the at least two support posts;
filtering the fresh air by the air filter; and
outflowing a filtered fresh air out through the air outlet into the cab.

15. The method of claim 14, wherein the cab further includes a roof with a roof airflow path therein, the at least one air intake opening is located in the roof, and the roof airflow path fluidly couples the at least one air intake opening with each respective airflow path of the at least two support posts.

16. The method of claim 15, wherein at least one support post of the at least two support posts including the airflow path therein includes at least one air intake port that is configured for intaking the fresh air such that the method step of intaking the fresh air additionally includes intaking the fresh air into each respective at least one air intake port.

17. The method of claim 16, wherein the at least two support posts each include a pair of air intake ports.

18. The method of claim 17, wherein the at least one air intake opening is in the form of one air intake opening located at a side of the roof of the cab, and the pair of air intake ports are respectively located at a top of each support post.

19. The method of claim 15, wherein the cab further includes a floor having a floor airflow path therein fluidly coupling each respective airflow path of the at least two support posts, the air filter is located at the floor of the cab, and the fresh air enters the at least one air intake opening, flows horizontally through the roof airflow path, flows downwardly through each respective airflow path of the at least two support posts, flows through the floor airflow path, and into the air filter such that the airflow into the cab is increased while the power consumption of the cab is decreased.

20. The method of claim 14, wherein the airflow system decreases the power consumption of the cab by being configured for decreasing a requisite load of a main blower and not including a designated pressurization blower.
